(19) United States
(12) Patent Application Publication
(10) Pub. No.: US 2011/0220017 A1
(43) Pub. Date: Sep. 15, 2011

(54) IMAGE FORMING APPARATUS

(75) Inventors: Satoshi KITAOKA, Kanagawa (JP); Kazuyoshi Matsumoto, Tokyo (JP); Shinji Imoto, Tokyo (JP); Kazuto Shibuya, Kanagawa (JP)

(73) Assignee: RICOH COMPANY, LTD, Tokyo (JP)

(21) Appl. No.: 13/045,809

(22) Filed: Mar. 11, 2011

(30) Foreign Application Priority Data
Mar. 13, 2010 (JP) 2010-056819

(51) Int. Cl. B05C 1/00; B05C 9/12; B05C 11/11; B05C 13/00

(52) U.S. Cl. 118/110

(57) ABSTRACT

An image forming apparatus includes an image forming unit for forming an image on a medium; and an application device for applying a treatment liquid to the medium. The application device includes a conveying roller; an application roller for applying the liquid; a squeeze roller for reducing the thickness of the liquid on the application roller; and a tray for supplying the liquid to the squeeze roller. In the application operation, the application and squeeze rollers come in contact, and a valley formed by these rollers faces upward. In the standby condition, at least one of the application and squeeze rollers is moved to such a position that the valley faces laterally. The tray always covers the lower side of the application and squeeze rollers in regions near the longitudinal end portions of the application roller, which end portions do not come in contact with the conveying roller.

### CROSS-REFERENCE TO RELATED APPLICATIONS

This patent application is based upon and claims the benefit of priority of Japanese Patent Application No. 2010-056819 filed on Mar. 13, 2010 the entire contents of which are incorporated herein by reference.

### BACKGROUND OF THE INVENTION

1. Field of the Invention

The present invention is generally directed to an image forming apparatus, and in particular to an image forming apparatus equipped with a device for applying a treatment liquid.

2. Description of the Related Art

Among image forming apparatuses such as printers, facsimile machines, copiers, plotters and multifunction peripherals having the aforementioned functions, there are liquid jet recording image forming apparatuses including, for example, a recording head for ejecting ink droplets. Such a liquid jet recording image forming apparatus is capable of ejecting ink droplets from its recording head onto a sheet being conveyed to form an image on the sheet. It is to be noted that the term “sheet” in this specification is not limited only to paper, and also applied to an OHP sheet or any medium on which ink droplets or other liquid can be applied, and may be referred to as a recording target medium, a recording medium, a recording paper, a recording sheet or the like. In addition, the terms “form”, “record”, “type”, “image”, and “print” may be regarded as synonymous with each other. The liquid jet recording image forming apparatuses include a serial-type image forming apparatus in which its recording head ejects droplets to form an image as moving in the main scanning direction, and a line-type image forming apparatus in which its recording head ejects droplets to form an image without moving.

Note that the liquid jet recording “image forming apparatus” in the present application refers to an apparatus capable of forming an image by ejecting liquid onto a medium such as a piece of paper, strings, fibers, fabric, leather, metal, plastic, glass, wood and ceramics. Further, the term “image forming” refers not only to forming an image having significant information such as letters or figures on a medium but also to forming an image having no significant meaning such as patterns on a medium (including a case where ink droplets are just discharged onto a medium). In addition, the term “ink” is not limited to a material generally called ink but refers to any material which becomes liquid upon being ejected, such as DNA samples, resists and pattern materials. The term “image” is not only directed to a planar image but also used for an image applied to a three-dimensional configuration and an image formed by shaping a solid object in three dimensions. In addition, the term “image forming apparatus” is not only directed to a liquid jet recording image forming apparatus but also applied to an electrophotographic image forming apparatus; however, the following description is given in terms of a liquid jet recording image forming apparatus.

In such a liquid jet recording image forming apparatus, image formation is made by causing an ink including a coloring material to break into liquid droplets. Because of this feature, such an image forming apparatus may have a drawback causing problems such as “feathering” in which each dot formed by an ink droplet spreads out in an irregular fashion (barb-like blur) and “color bleeding” in which when ink droplets having different colors are applied adjacent to each other on a sheet, the ink droplets are mixed on the boundary between the droplets, thereby causing fuzzy color boundary. In addition, another problem is that it takes time to dry the droplets after being applied to the sheet.

To overcome the above-mentioned problems, as is disclosed in Patent Document 1, a pretreatment liquid is applied to a recording medium using an application roller so as to react with ink droplets and thereby prevent ink bleeding. According to Patent Document 2, a pretreatment liquid is ejected in a mist form from a liquid ejection head (see also Patent Document 3). Patent Document 4 discloses an apparatus for applying a treatment liquid in foam form.
[Patent Document 1] Japanese Laid-open Patent Application Publication No. 2002-137378
[Patent Document 2] Japanese Laid-open Patent Application Publication No. 2005-138502
[Patent Document 3] Japanese Laid-open Patent Application Publication No. 2003-205673
[Patent Document 4] Japanese Laid-open Patent Application Publication No. 2009-012394

However, in the case when a treatment liquid is applied to a recording medium using a roller (application roller), the treatment liquid accumulates, at both ends of the roller, on the lateral surface of the roller, which results in ring-shaped swellings. If the ring-shaped swellings are left over a long period of time, the treatment liquid may drip to the inside of the image forming apparatus when the roller stops rotating.

Furthermore, at the time when the application of the treatment liquid is stopped, if the application roller and a squeeze roller stop while remaining under stress, the contact portion of the rollers is kept in contact with the treatment liquid, which may result in a change of properties of the rollers.

### SUMMARY OF THE INVENTION

Accordingly, embodiments of the present invention may provide a novel and useful image forming apparatus solving one or more of the problems discussed above.

In view of the above-described problems, the present invention aims at preventing a treatment liquid from dripping to the inside of the image forming apparatus when the application of the treatment liquid is not performed and also reducing the change of properties of the rollers.

One aspect of the present invention may be to provide an image forming apparatus including an image forming unit configured to form an image on a recording target medium; and an application device configured to apply a treatment liquid to the recording target medium. The application device includes a conveying roller for conveying the recording target medium; an application roller for applying the treatment liquid to the recording target medium; a squeeze roller for reducing the thickness of a liquid layer of the treatment liquid on the application roller; and a treatment liquid tray for supplying the treatment liquid to the squeeze roller and collecting the treatment liquid. When the application of the treatment liquid is performed, the application roller and the squeeze roller come in contact with each other, and a valley formed by the application roller and the squeeze roller and entrapping the treatment liquid faces in the upward direction. On the other hand, when the application of the treatment liquid is not performed, at least one of the application roller and the squeeze roller is moved to such a position that the valley faces in the lateral direction. The treatment liquid tray is disposed in such a position as to always cover the lower side of the application roller and the squeeze roller in regions near the longitudinal end portions of the application roller, which end portions do not come in contact with the conveying roller.

Another aspect of the present invention is an image forming apparatus including an image forming unit configured to form an image on a recording target medium; and an application device configured to apply a treatment liquid to the recording target medium. The application device includes an application roller for applying the treatment liquid to the recording target medium; a squeeze roller for reducing the thickness of a liquid layer of the treatment liquid on the application roller; and a liquid supply head for supplying the treatment liquid to a contact portion of the application roller and the squeeze roller. When the application of the treatment liquid is performed, the liquid supply head is disposed above the contact portion. On the other hand, when the application of the treatment liquid is not performed, the liquid supply head and at least one of the application roller and the squeeze roller are moved in such a manner that the liquid supply head is laterally disposed with respect to the contact portion.

Additional objects and advantages of the embodiments will be set forth in part in the description which follows, and in part may be obvious from the description, or may be learned by practice of the invention. The object and advantages of the invention may be realized and attained by means of the elements and combinations particularly pointed out in the appended claims.

It is to be understood that both the foregoing general description and the following detailed description are exemplary and explanatory only and are not restrictive of the invention as claimed.

### BRIEF DESCRIPTION OF THE DRAWINGS

FIG. 1 is a diagram showing an exemplary overall structure of an image forming apparatus according to a first embodiment of the present invention;

FIG. 2 is a schematic side view of an application unit of an application device in application operation according to the first embodiment of the present invention;

FIG. 3 is a sectional side view of the application unit in the application operation according to the first embodiment of the present invention;

FIG. 4 is a perspective view of the application unit in the application operation according to the first embodiment of the present invention, with a treatment liquid tray in a see-through view;

FIG. 5 is a sectional side view of the application unit in standby condition according to the first embodiment of the present invention;

FIG. 6 is a perspective view of the application unit in the standby condition according to the first embodiment of the present invention;

FIG. 7 is a flowchart showing operation of the application device according to the first embodiment of the present invention;

FIG. 8 is a flowchart subsequent to FIG. 7;

FIG. 9 is a sectional side view of an application unit of an application device in application operation according to a second embodiment of the present invention;

FIG. 10 is a perspective view of the application unit in the application operation according to the second embodiment of the present invention;

FIG. 11 is a sectional side view of the application unit in standby condition according to the second embodiment of the present invention;

FIG. 12 is a perspective view of the application unit in the standby condition according to the second embodiment of the present invention;

FIG. 13 is a flowchart showing operation of the application device according to the second embodiment of the present invention;

FIG. 14 is a flowchart subsequent to FIG. 13;

FIG. 15 is a flowchart showing operation of an application device according to a third embodiment of the present invention;

FIG. 16 is a flowchart subsequent to FIG. 15;

FIG. 17 is a flowchart showing operation of an application device according to a fourth embodiment of the present invention;

FIG. 18 is a flowchart subsequent to FIG. 17;

FIG. 19 is a schematic side view of an application unit of a first comparative example;

FIG. 20 is a perspective view of rollers of the application unit of the first comparative example;

FIG. 21 is a plan view of the rollers of the application unit of the first comparative example; and

FIG. 22 is a schematic side view of an application unit of a second comparative example.

### DETAILED DESCRIPTION OF THE PREFERRED EMBODIMENTS

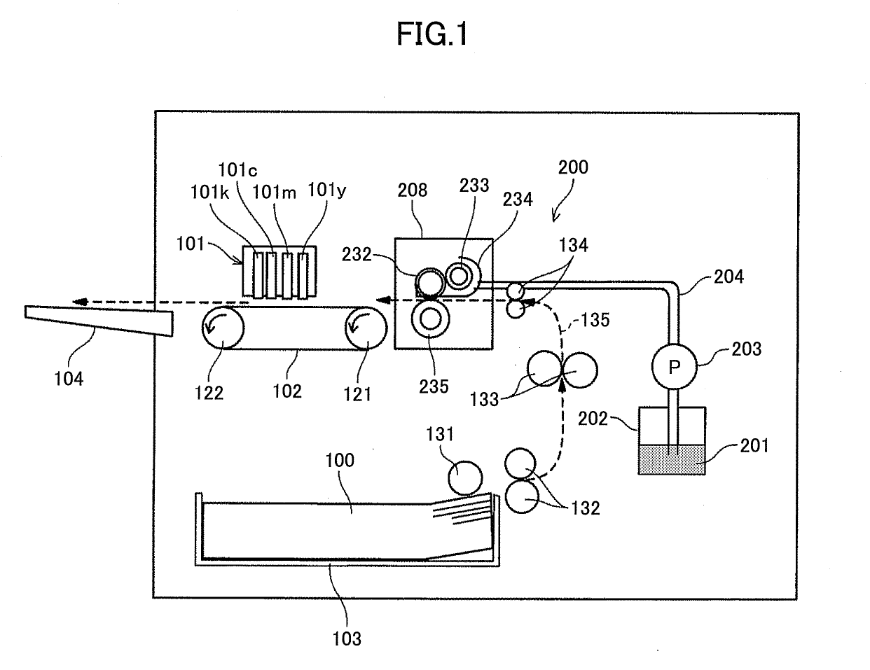

Embodiments that describe the best mode for carrying out the present invention are explained next with reference to the accompanying drawings. First, an example of an image forming apparatus according to a first embodiment of the present invention is described with reference to FIG. 1. FIG. 1 is a diagram showing an overall structure of the image forming apparatus.

The image forming apparatus includes a recording head unit 101 configured to serve as an image forming unit for forming an image by ejecting droplets onto a sheet 100, which is a recording target medium; a conveying belt 102 for conveying the sheet 100; a sheet feed tray 103 for housing the sheets 100; and an application device 200 for applying a treatment liquid to the sheet 100, which is an application target member, on the upstream side of the recording head unit 101 in the sheet conveyance direction.

The recording head unit 101 has line-type liquid ejection heads for ejecting droplets. Each of the line-type liquid ejection heads has plural nozzles arranged along the width direction of the sheet 100. That is, the recording head unit 101 includes recording heads 101y, 101m, 101c and 101k for ejecting yellow (Y), magenta (M), cyan (C) and black (K) ink-droplets, respectively. Note that the recording heads may be mounted on a carriage to form a serial-type image forming apparatus.

The conveying belt 102 is an endless belt extended between a conveying roller 121 and a tension roller 122 to rotate between the rollers. The sheet 100 may held to the conveying belt 102 using, for example, electrostatic attraction, vacuum suction, or other known holding means. Alternatively, a pair of rollers may be used to hold the sheet 100 during the conveyance.

The sheets 100 housed in the sheet feed tray 103 are picked up one by one by a pickup roller 131, and sent to a pair of resist rollers 133 by a pair of conveying rollers 132. Subsequently, by a pair of conveying rollers 134, each sheet 100 is sent from the paired resist rollers 133 at a predetermined timing to the application device 200 via a conveyance path 135. The application device 200 applies a treatment liquid to the sheet 100, which is then sent and held onto the conveying belt 102.

Then, while the sheet 100 is conveyed by the rotational movement of the conveying belt 102, droplets of each color are ejected from the head unit 101 onto the sheet 100 to thereby form an image. The sheet 100 is then discharged to a sheet eject tray 104.

The application device 200 includes a container 202 for housing a treatment liquid 201; a pump 203 for pumping the treatment liquid 201 out of the container 202; and an application unit 208 for applying the treatment liquid 201 supplied by the pump 203 via a supply channel 204 to the sheet 100, which is a recording target medium.

The treatment liquid 201 is a property modifying agent used to change properties of the surface of the sheet 100 when applied to the surface of the sheet 100. The treatment liquid 201 is, for example, a fixing agent (adhesive primer). When evenly applied in advance to the sheet 100 (which is not limited to a paper material, as mentioned above), the treatment liquid 201 prevents ink bleeding (i.e., feathering, color bleeding and the like) and strikethrough (i.e., a condition in which the ink passes through the sheet 100 and becomes visible on the back side of the sheet 100) by thickening color components of the ink while infiltrating water of the ink quickly into the sheet 100 and speeding up the drying process of the ink, and accordingly enables an improvement in productivity (the output number of sheets 100 with images per unit time).

The treatment liquid 201 may be a solution formed by adding a cellulose (for example, hydroxypropyl cellulose) for accelerating water infiltration and a base, such as fine-powder talc, to a surfactant agent (one selected from anionic, cationic and non-ionic surfactants, or a mixture of two or more of these surfactants). In addition, the treatment liquid 201 may include microparticles.

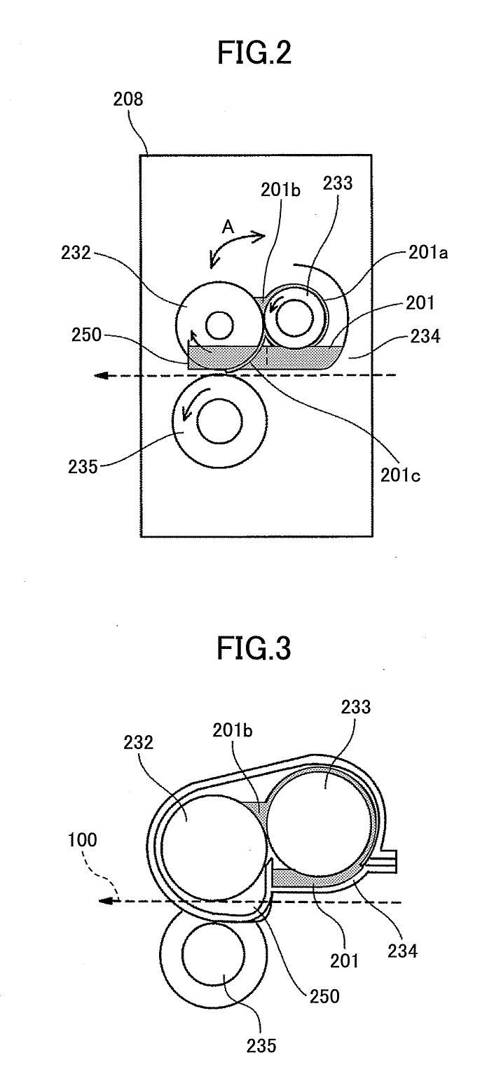

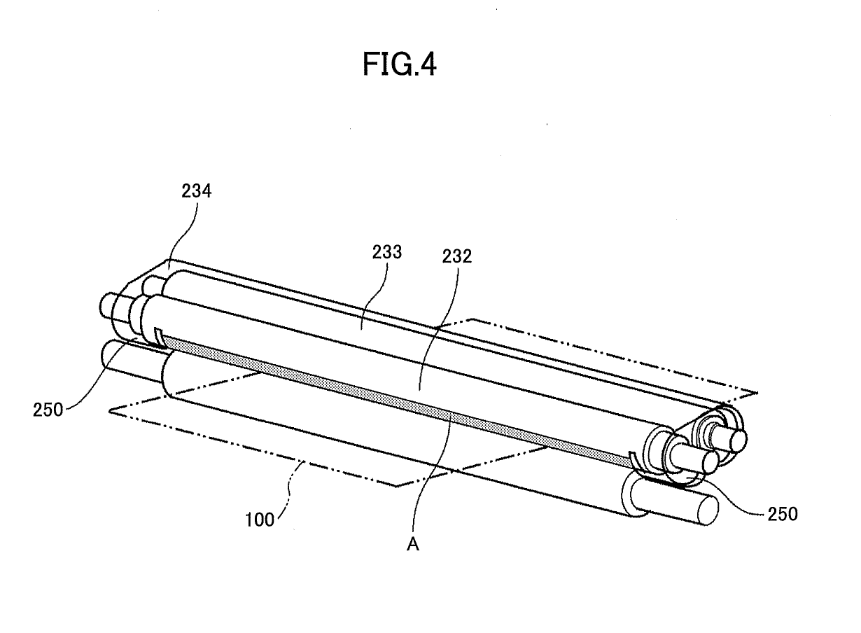

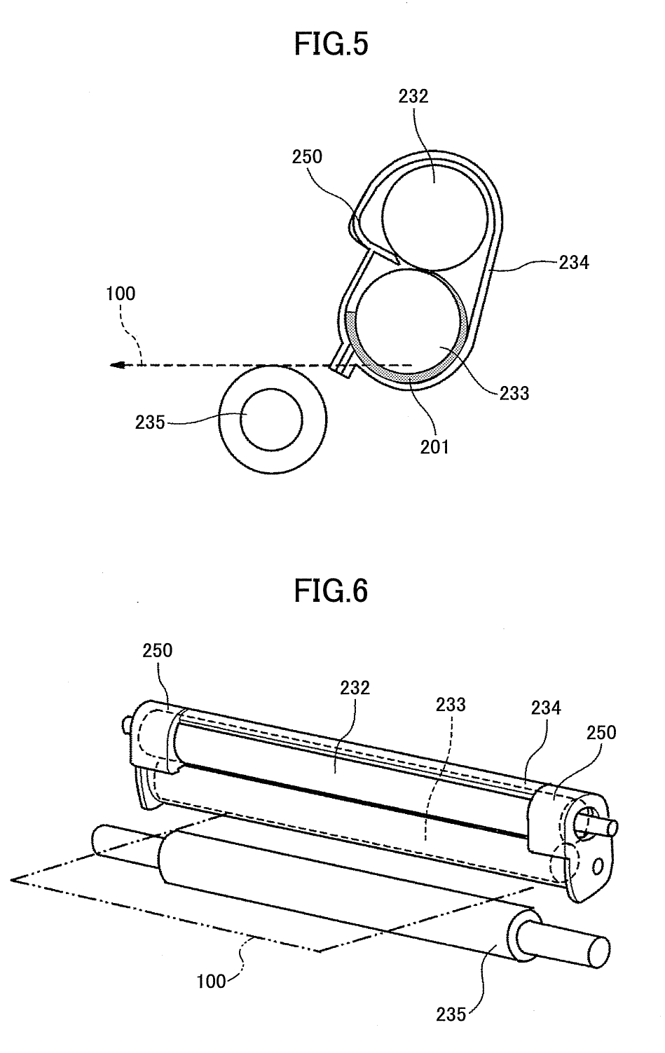

With reference to FIGS. 2 to 6, the following gives a detailed description of the application unit 208 of the application device 200 according to the first embodiment of the present invention. FIG. 2 is a schematic side view of the application unit 208 in application operation; FIG. 3 is a sectional side view of the application unit 208 in the application operation; FIG. 4 is a perspective view of the application unit 208 in the application operation, with a treatment liquid tray in a see-through view; FIG. 5 is a sectional side view of the application unit 208 in an inoperative condition (i.e., no application operation is in process); and FIG. 6 is a perspective view of the application unit 208 in the inoperative condition.

The application unit 208 includes a conveying roller 235 for conveying the sheet 100; an application roller 232 opposing and being in contact with the conveying roller 235 and configured to apply the treatment liquid 201 to the sheet 100; a squeeze roller 233 for reducing the thickness of the liquid layer of the treatment liquid 201 on the application roller 232; and a treatment liquid tray 234 for supplying and collecting the treatment liquid 201. Note that the rotational directions of the respective rollers are shown by the arrows in FIG. 2.

These rollers are disposed in such a manner that the application roller 232 is in contact with the conveying roller 235 and the squeeze roller 233 is in contact with the application roller 232. In addition, the squeeze roller 233 is disposed to be partially immersed in the treatment liquid 201 in the treatment liquid tray 234.

In the application unit 208, the application roller 232, the squeeze roller 233 and the treatment liquid tray 234 are provided in such a manner as to integrally sway (move) to change their positions between the condition shown in FIGS. 3 and 4 (referred to as the “application condition” or “application position”) and the condition shown in FIGS. 5 and 6 (referred to as the “standby (non-application) condition” or “standby (non-application) position”. The sway movement (the arrow A in FIG. 2 indicates directions of the movement) is controlled by not-shown driving means. Note that a region A in FIG. 4 indicates a contact portion of the application roller 232 and the conveying roller 235, which contact portion is disposed in accordance with an opening of the treatment liquid tray 234.

That is, in the application operation for applying the treatment liquid 201 to the recording target medium 100, the squeeze roller 233 and the application roller 232 move to the application position shown in FIGS. 3 and 4 and become laterally disposed in contact with one another. In this condition, a valley formed by the rollers 233 and 232 and entrapping the treatment liquid 201 faces in the upward direction.

In the application condition, the treatment liquid 201 is picked up from the treatment liquid tray 234 by the rotation of the squeeze roller 233, and then accumulates in the valley formed by the squeeze roller 233 and the application roller 232, as a treatment liquid 201b shown in FIGS. 2 and 3. The treatment liquid 201b thus accumulating in the valley is turned into a thin liquid layer when passing through a nip portion (i.e., the contact portion) of the application roller 232 and the squeeze roller 233 since these rollers 232 and 233 are in pressure contact with each other. Then, the treatment liquid 201 is applied to the recording target medium 100 passing through between the conveying roller 235 and the application roller 232.

When the application of the treatment liquid 201 is not performed (i.e., in the standby condition), the squeeze roller 233 and the application roller 232 move to the standby position shown in FIGS. 5 and 6 and become vertically disposed one above the other. In this condition, the valley for entrapping the treatment liquid 201 faces in the lateral direction, and therefore the treatment liquid 201b accumulating in the valley falls under its own weight to be collected in the treatment liquid tray 234.

The treatment liquid tray 234 is disposed in such a position as to, in either the application condition or the standby condition, always cover the lower side of the application roller 232 and the squeeze roller 233 in regions near the longitudinal end portions of the application roller 232, which end portions do not come in contact with the conveying roller 235. Herewith, it is possible to, without making a mess inside the image forming apparatus, quickly collect the treatment liquid 201 in a thickened mass left on the surface of the end portions of the application roller 232 since these end portions do not contribute to the application of the treatment liquid 201.

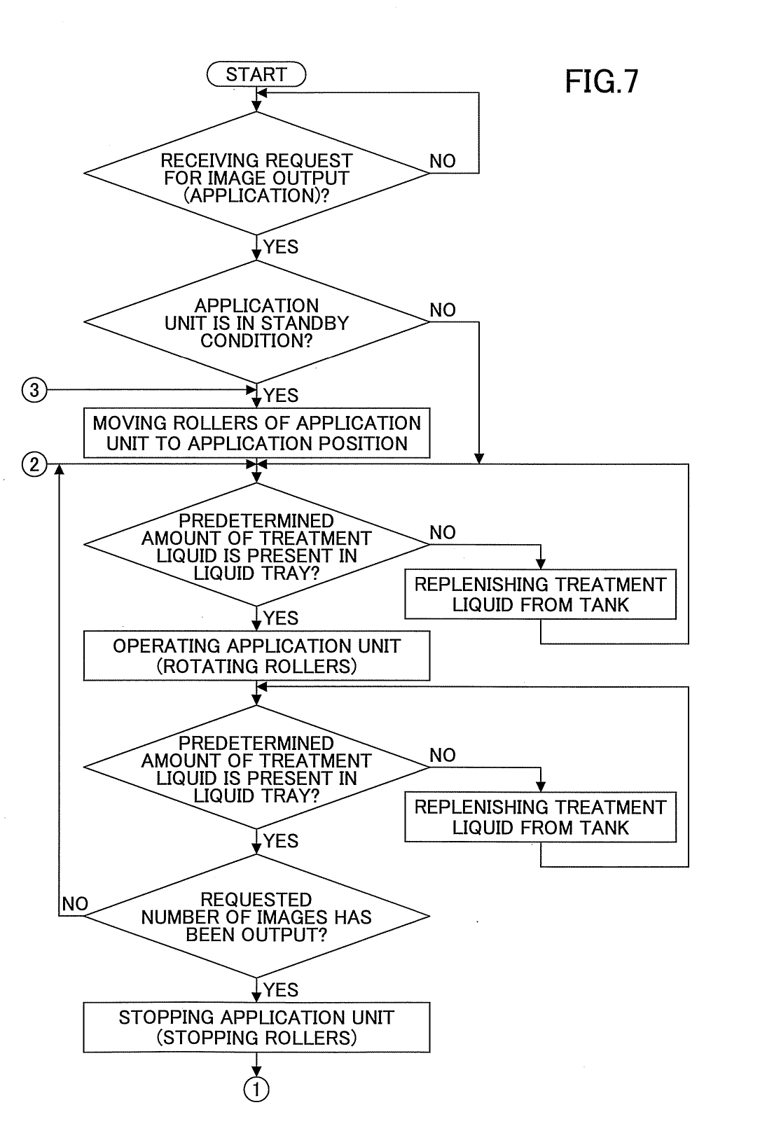

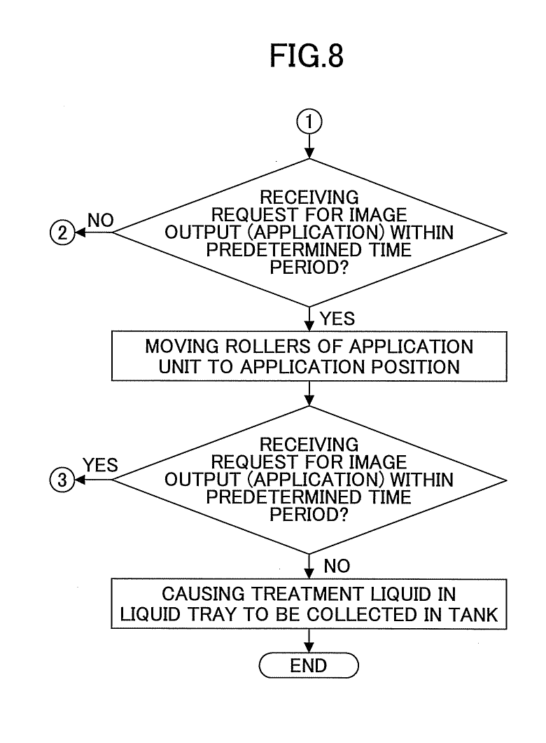

The operation of the application device 200 according to the present embodiment having the above-described configuration is explained next with reference to flowcharts of FIGS. 7 and 8.

First, referring to FIG. 7, on receiving a request for an image output (application operation), the application device 200 determines whether the application unit 208 is in the standby (non-application) condition. When determining that the application unit 208 is in the standby condition, the application device 200 causes the rollers 232 and 233 to move to the application position.

Subsequently, the application device 200 determines whether a predetermined amount of the treatment liquid 201 is present in the treatment liquid tray 234 (referred to as “liquid tray” in the figures; the same shall apply below in this specification). When determining that the predetermined amount of the treatment liquid 201 is not present, the application device 200 drives the pump 203 to supply (replenish) the treatment liquid 201 from the container 202 (referred to as “tank” in the figures; the same shall apply below in this specification) to the treatment liquid tray 234 until the predetermined amount of the treatment liquid 201 is obtained.

Next, the application device 200 rotates the squeeze roller 233 and the application roller 232 of the application unit 208. The application device 200 then determines whether the predetermined amount of the treatment liquid 201 is present in the treatment liquid tray 234. When determining that the predetermined amount of the treatment liquid 201 is not present, the application device 200 drives the pump 203 to supply (replenish) the treatment liquid 201 from the container 202 to the treatment liquid tray 234 until the predetermined amount of the treatment liquid 201 is obtained and thereby maintains the predetermined amount of the treatment liquid 201.

When all the requested number of images have been output, the application device 200 stops the rotation of the squeeze roller 233 and the application roller 232.

Now referring to FIG. 8, when receiving a subsequent request for an image output (application operation) within a predetermined period of time, the application device 200 repeats the above-described process. If not receiving a subsequent request for an image output (application operation) within the predetermined period of time, the application device 200 moves the rollers 232 and 233 to the standby position.

If receiving a further subsequent request for an image output (application operation) within a predetermined period of time, the application device 200 again moves the rollers 232 and 233 to the application position and repeats the above-described process.

When not receiving a further subsequent request for an image output (application operation) within the predetermined period of time after the rollers 232 and 233 are set to the standby position, the application device 200 causes the treatment liquid 201 in the treatment liquid tray 234 to be collected in the container 202.

Thus, when the application of the treatment liquid 201 is performed, the application roller 232 and the squeeze roller 233 come in contact with each other, and the valley for entrapping the treatment liquid 201 faces in the upward direction. On the other hand, when the application of the treatment liquid 201 is not performed, at least one of the application roller 232 and the squeeze roller 233 is moved to such a position that the valley for entrapping the treatment liquid 201 faces in the lateral direction. The treatment liquid tray 234 is disposed in such a position as to always cover the lower side of the application roller 232 and the squeeze roller 233 in regions near the longitudinal end portions of the application roller 232, which end portions do not come in contact with the conveying roller 235. Accordingly, this configuration prevents the treatment liquid 201 from dripping to the inside of the image forming apparatus when the application of the treatment liquid 201 is not performed, allows efficient use of the treatment liquid 201, and reduces the change of properties of the rollers 232 and 233.

That is, when the application of the treatment liquid 201 is performed, the treatment liquid 201 is picked up along the surface of the squeeze roller 233 and then accumulates in the valley formed by the squeeze roller 233 and the application roller 232, as described above. The treatment liquid 201 that remains on the surfaces of the rollers 232 and 233 after being not used for the application moves along the roller surfaces. Here, the treatment liquid 201 remaining on the surface of the application roller 232 returns to the valley after going around the application roller 232, and the treatment liquid 201 remaining on the surface of the squeeze roller 233 is collected when the corresponding part of the squeeze roller 233 is immersed in the treatment liquid 201 in the lowly-placed treatment liquid tray 234. The treatment liquid 201 having returned to the valley and been collected in the treatment liquid tray 234 in this manner is used again.

In the case where the application operation is stopped when the squeeze roller 233 and the application roller 232 are laterally disposed with respect to one another (abnormal condition), some of the treatment liquid 201 that remains on the surface of the application roller 232 after being not used for the application and cannot be returned to the treatment liquid tray 234 is housed in a liquid tray 250.

Thus, by forming the liquid tray 250 in such a manner as to cover the lower side of the application roller 232, it is possible to prevent the treatment liquid 201 from making a mess inside the image forming apparatus even in an abnormal condition. Note that the liquid tray 250 is provided only around the end portions of the application roller 232, which end portions do not come in contact with the conveying roller 235. At the part of the application roller 232 which comes in contact with the conveying roller 235, dripping of the treatment liquid 201 does not occur in a short amount of time since the liquid layer is formed in a thin film; however, at the end portions of the application roller 232, dripping of the treatment liquid 201 occurs in a short period of time after the application operation is stopped since the liquid layer is thick. Accordingly, a sufficient effect can be obtained by providing the liquid tray 250 only around the end portions of the application roller 232, which end portions do not come in contact with the conveying roller 235.

In the standby condition, the squeeze roller 233 and the application roller 232 are vertically disposed one above the other (in the upright direction), and thereby it is possible to collect in the treatment liquid tray 234 all the treatment liquid 201 remaining on the surfaces of the squeeze roller 233 and the application roller 232 and in the valley and use the collected treatment liquid 201 again when the application operation is resumed.

When the application operation is resumed after being stopped in the condition where the squeeze roller 233 and the application roller 232 are laterally disposed with respect to one another (abnormal condition), the squeeze roller 233 and the application roller 232 are once moved to the standby position (in the upright direction). Herewith, it is possible to collect in the treatment liquid tray 234 all the treatment liquid 201 remaining on the surfaces of the squeeze roller 233 and the application roller 232 and in the valley as well as the treatment liquid 201 housed in the liquid tray 250, and use the collected treatment liquid 201 again when the application operation is resumed.

In view of the case where the non-application condition continues for a long period of time, the pump 203 may be formed of a reversible pump. Alternatively, a treatment liquid discharge path may be additionally provided to bring the treatment liquid 201 collected in the treatment liquid tray 234 back to the container 202. Herewith, it is possible to further reduce the change of properties of the rollers 232 and 233 by the treatment liquid 201, and also prevent the change of properties of the treatment liquid 201 itself.

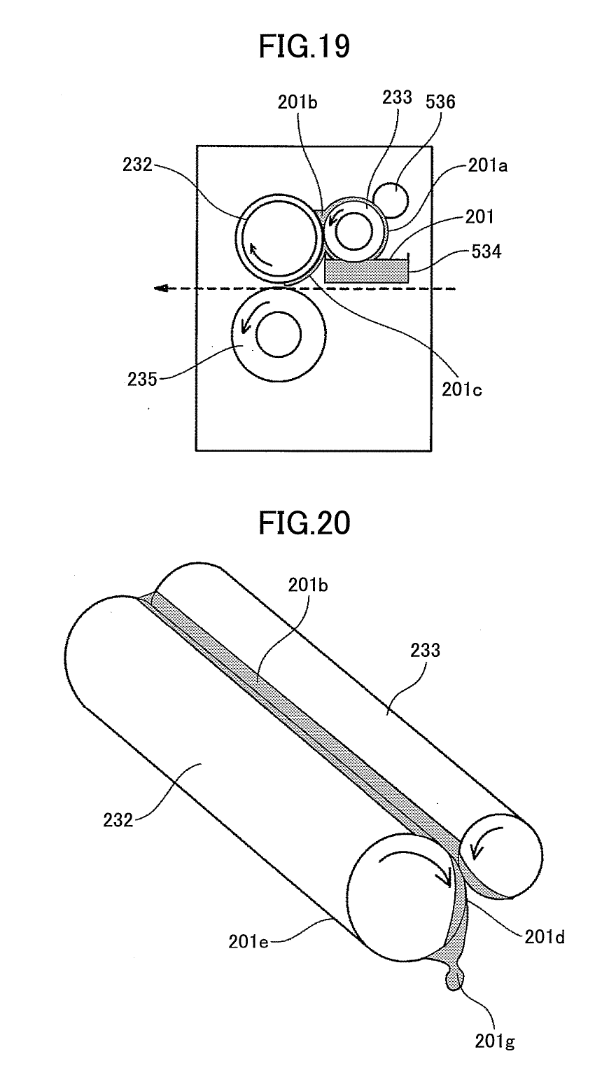

Next is described a comparative example 1 with reference to FIGS. 19 to 21 and a comparative example 2 with reference to FIG. 22.

In the comparative example 1, the treatment liquid 201 in a treatment liquid tray 534 is picked up by the squeeze roller 233, then made to be a liquid film layer 201a by a regulating roller 536, and supplied to the application roller 232 using the squeeze roller 233.

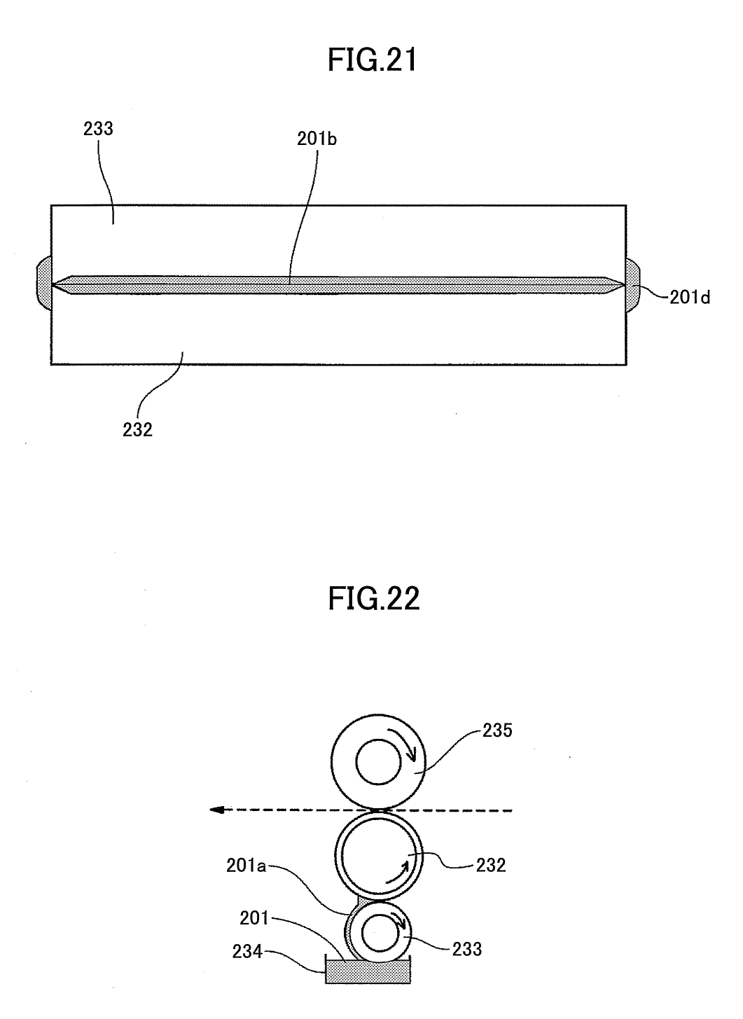

According to the configuration of the comparative example 1, the treatment liquid 201 transferred by the squeeze roller 233 accumulates in the valley formed by the squeeze roller 233 and the application roller 232 as the treatment liquid 201b. If the rollers 233 and 232 go into standby in this condition, the treatment liquid 201b accumulating in the valley overflows from the end portions of the rollers 233 and 232, as a liquid 201d shown in FIGS. 20 and 21. If this situation goes on, the overflowing liquid 201d drips to the inside of the image forming apparatus, as liquid dripping 201g shown in FIG. 20.

The comparative example 2 has a configuration in which the application roller 232 is disposed above the squeeze roller 233, and the conveying roller 235 is disposed above the application roller 232. According to the configuration, when the rollers 233 and 232 stop their operation, the treatment liquid 201 remaining on the rollers 233 and 232 falls into the lowly-placed treatment liquid tray 234 under its gravity.

According to the configuration of the comparative example 2, the treatment liquid 201 is applied to the lower surface of the sheet 100. However, in the case where the treatment liquid 201 is applied as a pretreatment in an inkjet recording apparatus or the like, the application of the treatment liquid 201 is preferably performed immediately before a printing job starts. This is because the reaction between the treatment liquid 201 and an ink is carried out in the form of liquids. Therefore, in the case of performing the application operation of the treatment liquid 201 in the inkjet recording apparatus, it is generally preferable to apply the treatment liquid 201 to the upper surface of the recording target medium 100. As a result, the configuration of the comparative example 2 does not meet the demand for the application operation of the treatment liquid 201 in such an inkjet recording apparatus.

In view of these problems, the application device 200 according to the first embodiment of the present invention has a configuration in which the squeeze roller 233 and the application roller 232 are laterally disposed with respect to one another during the application operation, and in the standby condition, the rollers 233 and 232 are vertically disposed one above the other and the treatment liquid tray 234 is always disposed below the squeeze roller 233. Herewith, it is possible to prevent the treatment liquid 201 from dripping from the end portions of the rollers 233 and 232 during the standby period and collect the treatment liquid 201 from the rollers 233 and 232.

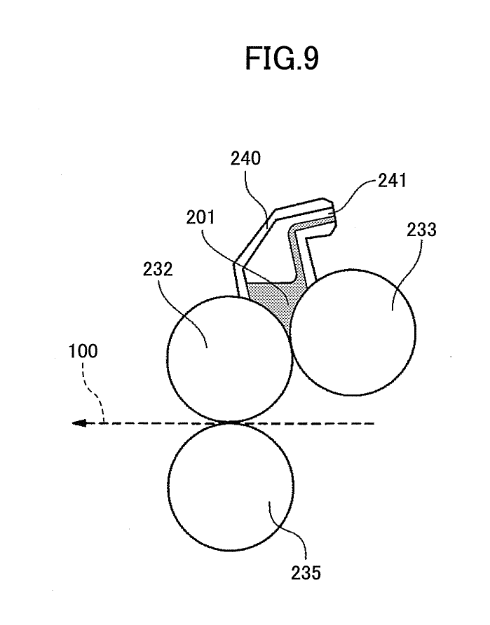

Next is described an application device according to a second embodiment of the present invention with reference to FIGS. 9 to 12.

According to the second embodiment, a liquid supply head 240 for supplying the treatment liquid 201 is provided at the nip portion of the squeeze roller 233 and the application roller 232. The liquid supply head 240 includes a liquid inlet opening 241 which is connected to the supply channel 204.

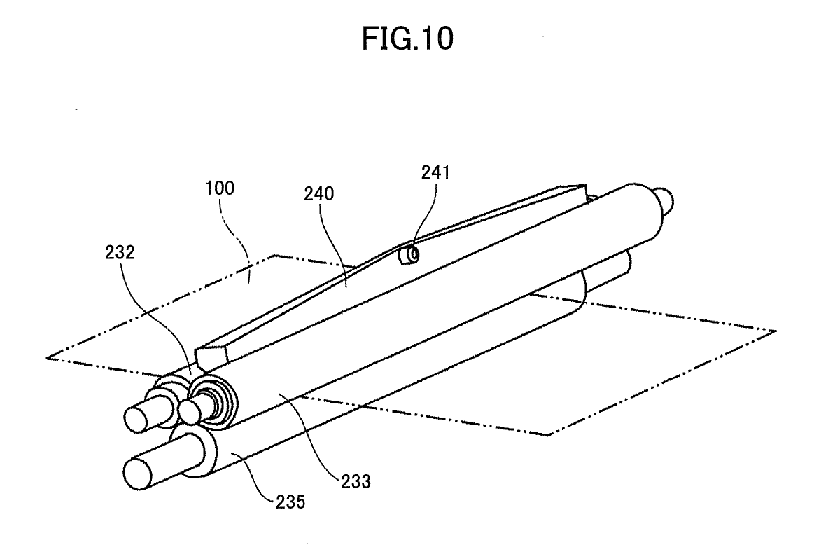

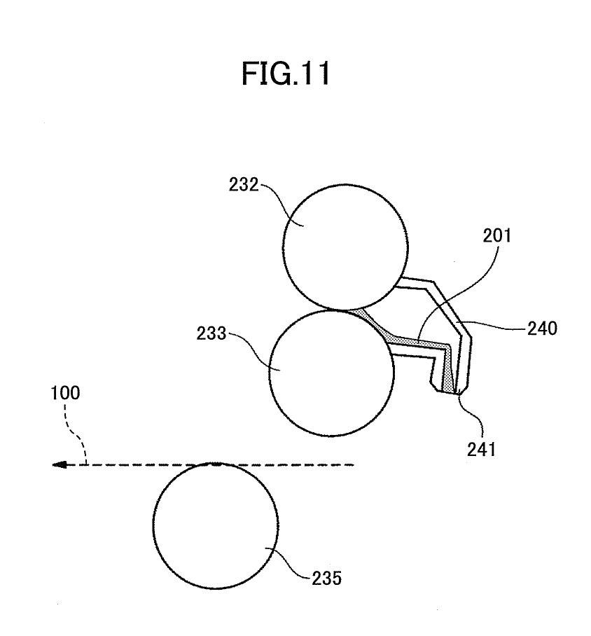

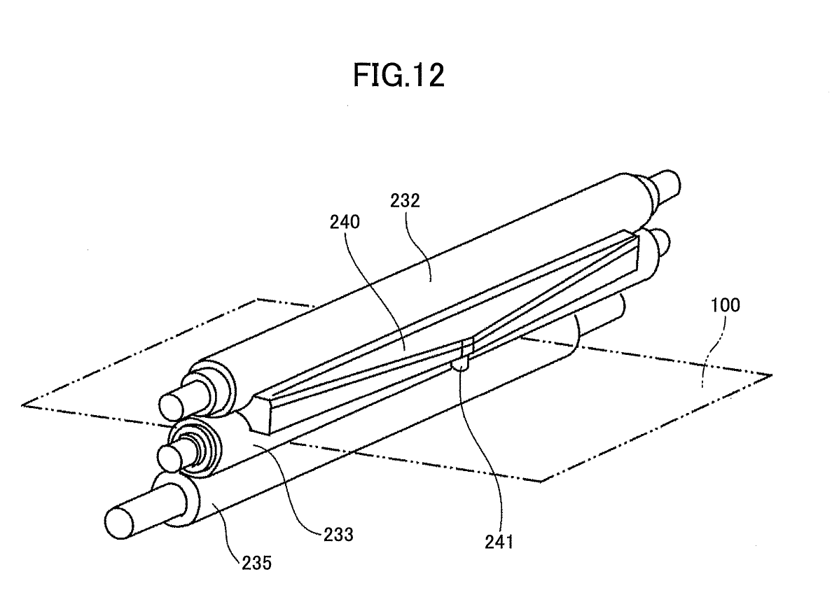

The application roller 232, the squeeze roller 233 and the liquid supply head 240 are provided in such a manner as to integrally sway (move) to change their positions between the condition shown in FIGS. 9 and 10 (referred to as the “application condition” or “application position”) and the condition shown in FIGS. 11 and 12 (referred to as the “standby (non-application) condition” or “standby (non-application) position”. Here, these components are configured to sway together; however, the structure is not limited to this case, and for example, all the components may pivot around the axis of one roller (i.e., the roller having the pivot axis does not sway) instead.

That is, in the application operation for applying the treatment liquid 201 to the recording target medium 100, the squeeze roller 233 and the application roller 232 move to the application position shown in FIGS. 9 and 10 and become laterally disposed in contact with one another. In this condition, the valley formed by the rollers 233 and 232 and entrapping the treatment liquid 201 faces in the upward direction.

In the application condition, the treatment liquid 201b accumulates in the valley formed by the squeeze roller 233 and the application roller 232 by supply from the liquid supply head 240. The treatment liquid 201b thus accumulating in the valley is turned into a thin liquid layer when passing through the nip portion (i.e., the contact portion) of the application roller 232 and the squeeze roller 233 since these rollers are in pressure contact with each other. Then, the treatment liquid 201 is applied to the recording target medium 100 passing through between the conveying roller 235 and the application roller 232.

When the application of the treatment liquid 201 is not performed (i.e., in the standby condition), the squeeze roller 233 and the application roller 232 move to the standby position shown in FIGS. 11 and 12 and become vertically disposed one above the other. In this condition, the valley for entrapping the treatment liquid 201 faces in the lateral direction and the liquid supply head 240 is also disposed in the lateral direction, and therefore the treatment liquid 201b accumulating in the valley is moved toward the liquid inlet opening 241 in the liquid supply head 240 and collected there.

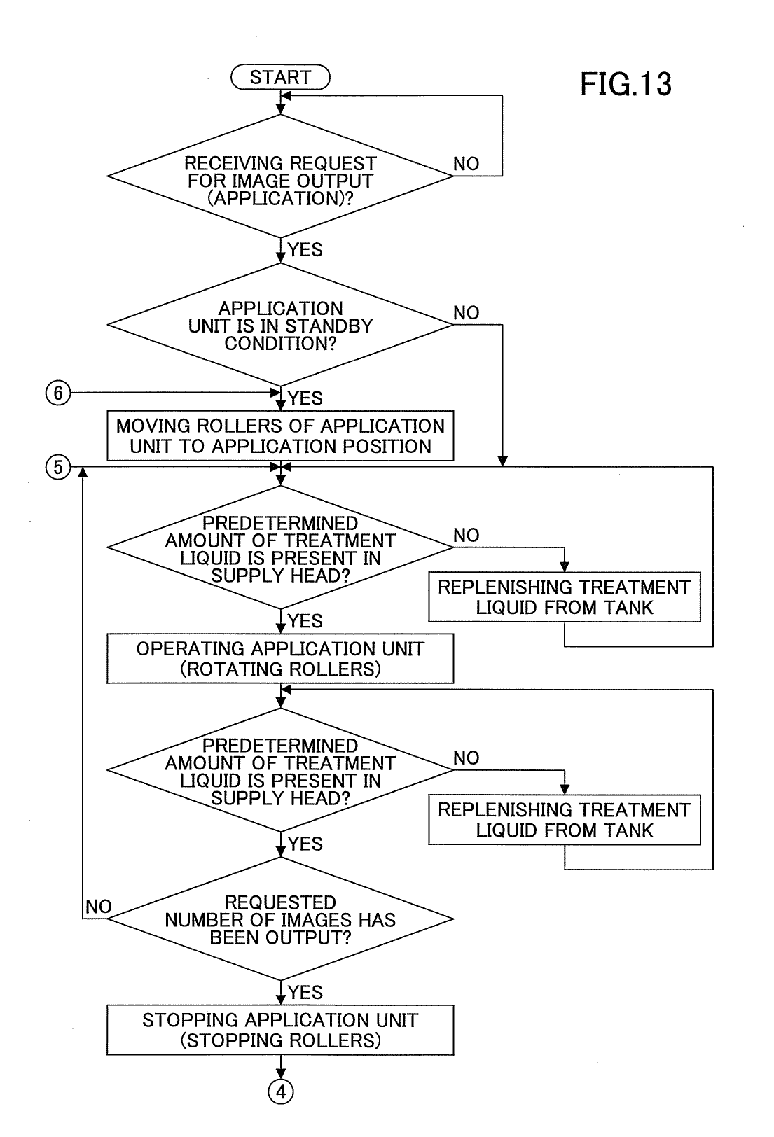

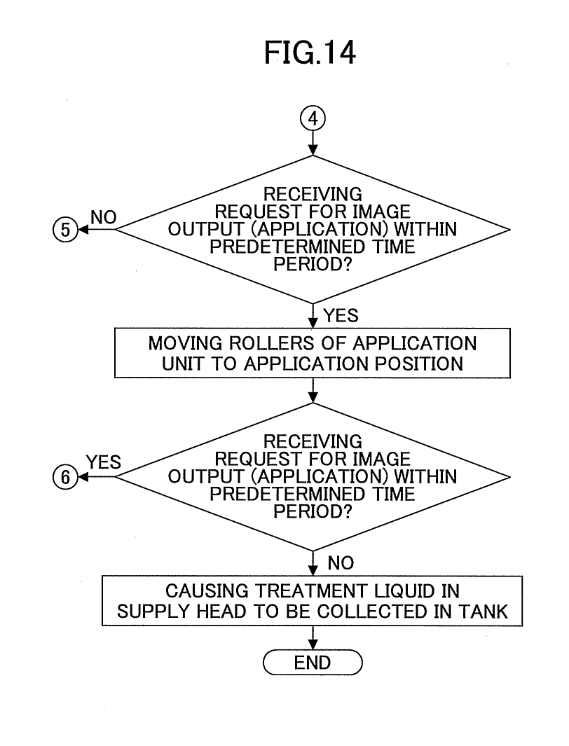

The operation of the application device 200 according to the present embodiment having the above-described configuration is explained next with reference to flowcharts of FIGS. 13 and 14.

First, referring to FIG. 13, on receiving a request for an image output (application operation), the application device 200 determines whether the application unit 208 is in the standby (non-application) condition. When determining that the application unit 208 is in the standby condition, the application device 200 causes the rollers 232 and 233 and the liquid supply head 240 to move to the application position.

Subsequently, the application device 200 determines, using not-shown liquid level detecting means provided in the liquid supply head 240, whether a predetermined amount of the treatment liquid 201 is present in the liquid supply head 240. When determining that the predetermined amount of the treatment liquid 201 is not present, the application device 200 drives the pump 203 to supply (replenish) the treatment liquid 201 from the container 202 to the liquid supply head 240 until the predetermined amount of the treatment liquid 201 is obtained.

Next, the application device 200 rotates the squeeze roller 233 and the application roller 232 of the application unit 208. The application device 200 then determines whether the predetermined amount of the treatment liquid 201 is present in the liquid supply head 240. When determining that the predetermined amount of the treatment liquid 201 is not present, the application device 200 drives the pump 203 to supply (replenish) the treatment liquid 201 from the container 202 to the liquid supply head 240 until the predetermined amount of the treatment liquid 201 is obtained and thereby maintains the predetermined amount of the treatment liquid 201.

When all the requested number of images have been output, the application device 200 stops the rotation of the squeeze roller 233 and the application roller 232.

Now referring to FIG. 14, when receiving a subsequent request for an image output (application operation) within a predetermined period of time, the application device 200 repeats the above-described process. If not receiving a subsequent request for an image output (application operation) within the predetermined period of time, the application device 200 moves the rollers 232 and 233 and the liquid supply head 240 to the standby position.

If receiving a further subsequent request for an image output (application operation) within a predetermined period of time, the application device 200 again moves the rollers 232 and 233 and the liquid supply head 240 to the application position and repeats the above-described process.

When not receiving a further subsequent request for an image output (application operation) within the predetermined period of time after the rollers 232 and 233 and the liquid supply head 240 are set to the standby position, the application device 200 causes the treatment liquid 201 in the liquid supply head 240 to be collected in the container 202.

Thus, when the application of the treatment liquid 201 is performed, the liquid supply head 240 is disposed above the contact portion of the application roller 232 and the squeeze roller 233. On the other hand, when the application of the treatment liquid 201 is not performed, the application roller 232, the squeeze roller 233 and the liquid supply head 240 are moved in such a manner that the liquid supply head 240 is laterally disposed with respect to the contact portion of the application roller 232 and the squeeze roller 233. Accordingly, this configuration prevents the treatment liquid 201 from dripping to the inside of the image forming apparatus when the application of the treatment liquid 201 is not performed and reduces the change of properties of the rollers 232 and 233.

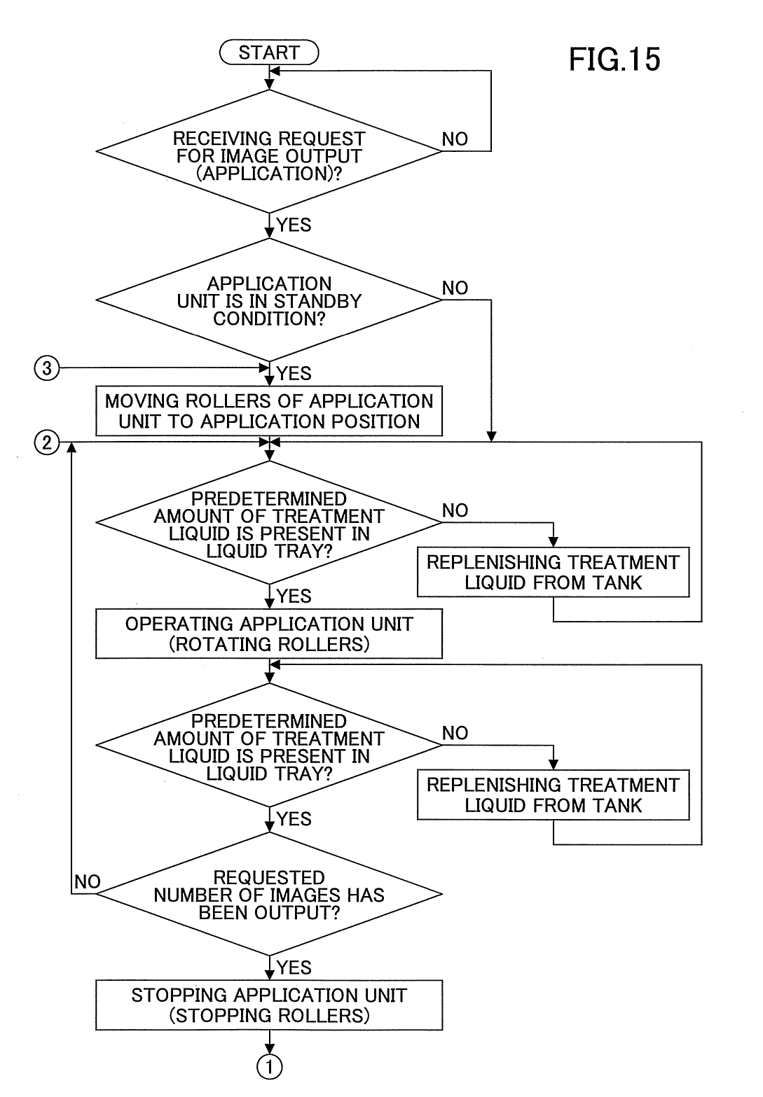

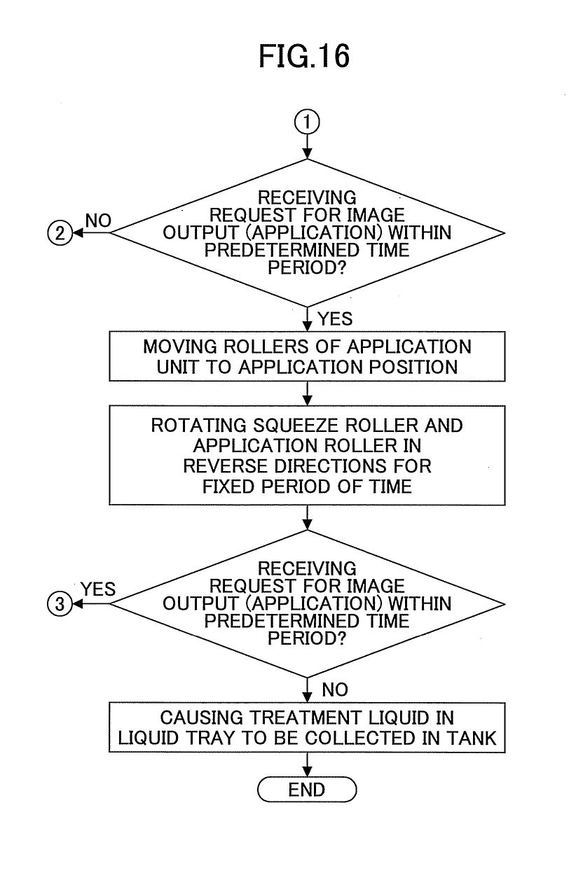

The operation of the application device 200 according to a third embodiment is explained next with reference to flowcharts of FIGS. 15 and 16.

Here, in processes similar to those of the first embodiment, when the application roller 232 and the squeeze roller 233 are moved to the standby position since a subsequent request for an image output (application operation) is not received within the predetermined period of time after all the previously requested number of images are output and the rotation of the squeeze roller 233 and the application roller 232 is stopped, the squeeze roller 233 and the application roller 232 are respectively rotated for a fixed period of time in the reverse directions from their rotational directions in the application operation.

In the standby condition, since the squeeze roller 233 and the application roller 232 are vertically disposed one above the other and the valley for entrapping the treatment liquid 201 faces in the lateral direction, most of the treatment liquid 201b accumulating in the valley falls under its own weight to be collected in the treatment liquid tray 234. However, some of the treatment liquid 201 remains at the bottom of the valley by surface tension. Accordingly, by causing the squeeze roller 233 and the application roller 232 to respectively rotate for a fixed period of time in the reverse directions from their rotational directions in the application operation, it is possible to collect, in the treatment liquid tray 234, the treatment liquid 201b accumulating at the bottom of the valley.

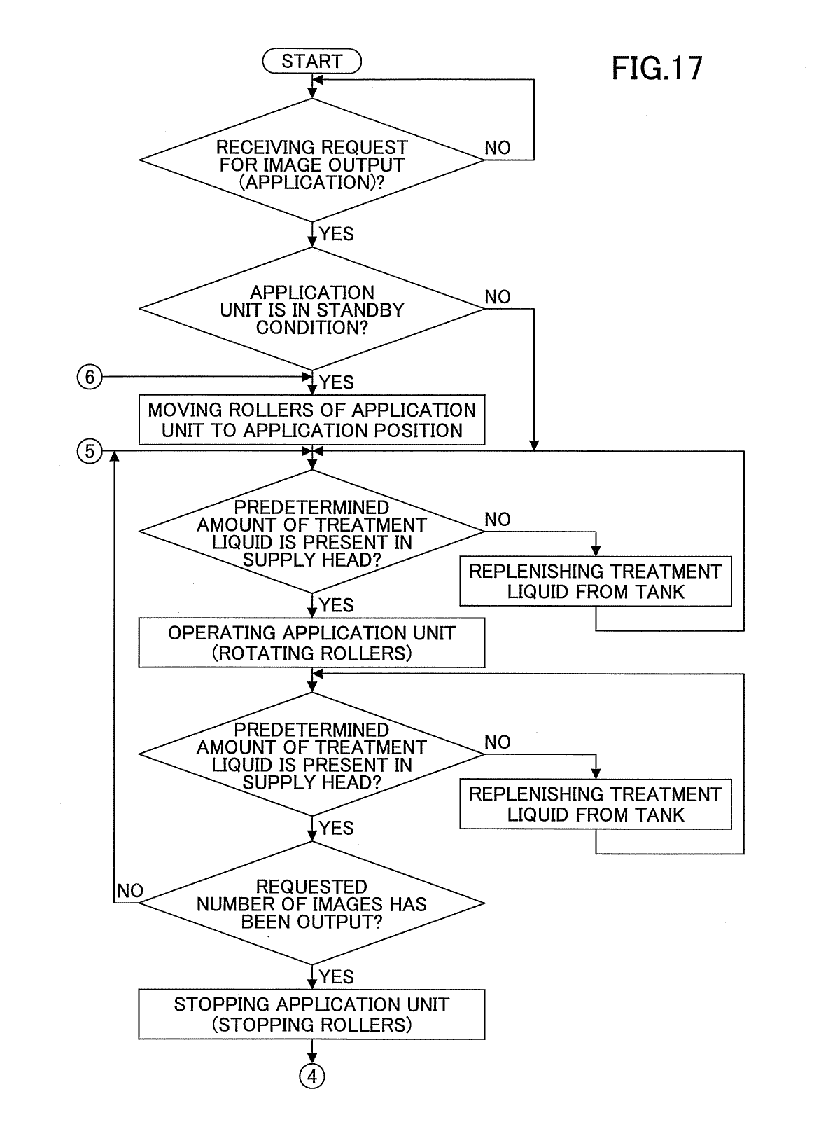

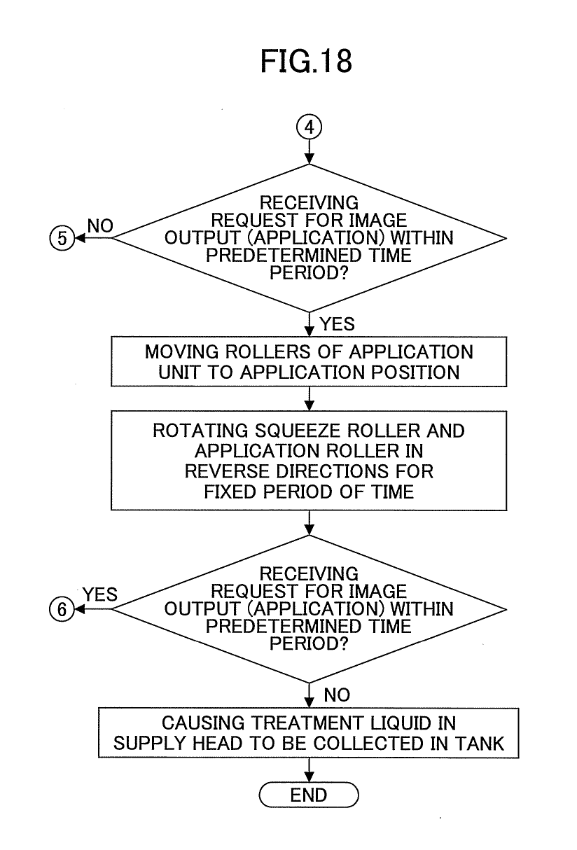

The operation of the application device 200 according to a fourth embodiment is explained next with reference to flowcharts of FIGS. 17 and 18.

Here, in the same manner as the third embodiment of the present invention, the step of reversing the rotation of the squeeze roller 233 and the application roller 232 is introduced to processes similar to those of the second embodiment. That is, when the application roller 232, the squeeze roller 233 and the liquid supply head 240 are moved to the standby position since a subsequent request for an image output (application operation) is not received within the predetermined period of time after all the previously requested number of images are output and the rotation of the squeeze roller 233 and the application roller 232 is stopped, the squeeze roller 233 and the application roller 232 are respectively rotated for a fixed period of time in the reverse directions from their rotational directions in the application operation.

In the standby condition, since the squeeze roller 233 and the application roller 232 are vertically disposed one above the other and the valley for entrapping the treatment liquid 201 faces in the lateral direction, most of the treatment liquid 201b accumulating in the valley is moved toward the liquid supply head 240 under its gravity and collected there. However, some of the treatment liquid 201 remains at the bottom of the valley by surface tension. Accordingly, by causing the squeeze roller 233 and the application roller 232 to respectively rotate for a fixed period of time in the reverse directions from their rotational directions in the application operation, it is possible to move the treatment liquid 201b accumulating at the bottom of the valley toward the supply head 240 to be collected.

In the above-described embodiments, the treatment liquid application device performs the application of the treatment liquid to a sheet prior to image formation on the sheet. However, the treatment liquid may be applied, on the downstream side of the recording head unit, to a sheet on which an image has been formed.

The present invention is applicable, for example, to electrophotographic image forming apparatuses. In addition, the present invention is also applicable to a fixing method, a fixing apparatus, and image forming method and an image forming apparatus which use a fixing liquid enabling, when applied to a medium (for example, a sheet of paper) to which fine particles (such as toner) containing resin have adhered, the resin-containing particles to be quickly fixed to the medium without causing an adverse effect on the resin-containing particles, and also enabling application in micro amounts so as not to leave greasiness on the medium.

In conclusion, according to the image forming apparatus of the present invention, when the application of the treatment liquid is performed, the application roller and the squeeze roller come in contact with each other, and the valley formed by these rollers and entrapping the treatment liquid faces in the upward direction. On the other hand, when the application of the treatment liquid is not performed, at least one of the application roller and the squeeze roller is moved to such a position that the valley for entrapping the treatment liquid faces in the lateral direction. The treatment liquid tray is disposed in such a position as to always cover the lower side of the application roller and the squeeze roller in regions near the longitudinal end portions of the application roller, which end portions do not come in contact with the conveying roller. Accordingly, this configuration prevents the treatment liquid from dripping to the inside of the image forming apparatus when the application of the treatment liquid is not performed and reduces the change of properties of the rollers.

In addition, according to the image forming apparatus of the present invention, when the application of the treatment liquid is performed, the liquid supply head is disposed above the contact portion of the application roller and the squeeze roller. On the other hand, when the application of the treatment liquid is not performed, the liquid supply head and at least one of the application roller and the squeeze roller are moved in such a manner that the liquid supply head is laterally disposed with respect to the contact portion of the application roller and the squeeze roller. Accordingly, this configuration prevents the treatment liquid from dripping to the inside of the image forming apparatus when the application of the treatment liquid is not performed and reduces the change of properties of the rollers.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiments of the present invention have been described in detail, it should be understood that the various changes, substitutions, and alterations could be made hereto without departing from the spirit and scope of the invention.

What is claimed is:

1. An image forming apparatus comprising:
an image forming unit configured to form an image on a recording target medium; and
an application device configured to apply a treatment liquid to the recording target medium,
wherein the application device includes a conveying roller for conveying the recording target medium; an application roller for applying the treatment liquid to the recording target medium; a squeeze roller for reducing thickness of a liquid layer of the treatment liquid on the application roller; and a treatment liquid tray for supplying the treatment liquid to the squeeze roller and collecting the treatment liquid,
when the application of the treatment liquid is performed, the application roller and the squeeze roller come in contact with each other, and a valley formed by the application roller and the squeeze roller and entrapping the treatment liquid faces in an upward direction,
when the application of the treatment liquid is not performed, at least one of the application roller and the squeeze roller is moved to such a position that the valley faces in a lateral direction, and
the treatment liquid tray is disposed in such a position as to always cover a lower side of the application roller and the squeeze roller in regions near longitudinal end portions of the application roller, which end portions do not come in contact with the conveying roller.

2. An image forming apparatus comprising:
an image forming unit configured to form an image on a recording target medium; and
an application device configured to apply a treatment liquid to the recording target medium,
wherein the application device includes an application roller for applying the treatment liquid to the recording target medium; a squeeze roller for reducing thickness of a liquid layer of the treatment liquid on the application roller; and a liquid supply head for supplying the treatment liquid to a contact portion of the application roller and the squeeze roller,
when the application of the treatment liquid is performed, the liquid supply head is disposed above the contact portion, and
when the application of the treatment liquid is not performed, the liquid supply head and at least one of the application roller and the squeeze roller are moved in such a manner that the liquid supply head is laterally disposed with respect to the contact portion.

3. The image forming apparatus as claimed in claim 1, wherein when the application of the treatment liquid is not performed, the application roller and the squeeze roller are respectively rotated for a fixed period of time in reverse directions from rotational directions thereof used in the application of the treatment liquid.

4. The image forming apparatus as claimed in claim 2, wherein when the application of the treatment liquid is not performed, the application roller and the squeeze roller are respectively rotated for a fixed period of time in reverse directions from rotational directions thereof used in the application of the treatment liquid.
